(19) United States
(12) Patent Application Publication
(10) Pub. No.: US 2023/0165281 A1
(43) Pub. Date: Jun. 1, 2023

(54) METHODS AND COMPOSITIONS FOR PROVIDING A HEALTH BENEFIT IN AN ANIMAL

(71) Applicant: Société des Produits Nestlé S.A., Vevey (CH)

(72) Inventors: Yuanlong Pan, Chesterfield, MO (US); Hui Xu, Chesterfield, MO (US); Sandeep Bhatnagar, Ballwin, MO (US); Julie Kristine Spears, St. Louis, MO (US)

(21) Appl. No.: 18/070,393

(22) Filed: Nov. 28, 2022

Related U.S. Application Data
(60) Provisional application No. 63/283,865, filed on Nov. 29, 2021.

(51) Int. Cl. A23K 50/40; A23K 20/147; A23K 20/158; A23K 20/163; A23K 20/121

(52) U.S. Cl. CPC A23K 50/40; A23K 20/147; A23K 20/158; A23K 20/163; A23K 20/121

(57) ABSTRACT

The present disclosure provides compositions and methods for providing a health benefit in an animal comprising administering a food composition to the animal, where the food composition comprises protein, fat, carbohydrates, omega-3 fatty acids, and isoflavones; where the protein to carbohydrate is in a ratio ranging from 3.5:1 to 2.5:1 by weight as fed.

### CROSS REFERENCE TO RELATED APPLICATIONS

This application claims the benefit of and priority to U.S. Provisional Application Ser. No. 63/283,865 filed Nov. 29, 2021, the disclosure of which is incorporated in its entirety herein by this reference.

### BACKGROUND

Obese and overweight animals have an increased risk of many chronic diseases including heart disease, diabetes, hypertension, stroke, dyslipidemia, certain types of cancer, apnea and osteoarthritis. Therefore, it is essential for overweight and obese animals, including humans and pets, to lose excessive body fat to maintain health and quality of life. Unfortunately, losing excessive body fat or maintaining healthy weight after weight loss is difficult to achieve and various solutions can have adverse consequences, e.g., loss of lean body mass or weight rebound after weight loss.

Obesity is among the most serious health problems in humans and pets and considered to be the leading preventable cause of death. Maintaining a healthy weight is critical for optimal metabolism, normal physical activity and good health. There is, therefore, a need for methods and compositions to increase satiety, promote weight loss, and/or maintain healthy weight, for better the health and wellness of animals.

### SUMMARY

In one embodiment, a pet food composition can comprise protein, fat, carbohydrates, omega-3 fatty acids, and isoflavones; wherein the protein to carbohydrate is in a ratio ranging from 3.5:1 to 2.5:1 by weight as fed.

In another embodiment, a method for providing a health benefit in an animal can comprise administering a food composition to the animal, wherein the food composition comprises protein, fat, carbohydrates, omega-3 fatty acids, and isoflavones; wherein the protein to carbohydrate is in a ratio ranging from 3.5:1 to 2.5:1 by weight as fed.

Other and further objects, features, and advantages of the invention will be readily apparent to those skilled in the art.

### DETAILED DESCRIPTION

### Definitions

The term “animal” means any animal that would benefit from the health benefits described herein, including human, avian, bovine, canine, equine, feline, hircine, lupine, murine, ovine, or porcine animals. In one aspect, the animal can be a mammal.

The term “companion animal” means domesticated animals such as cats, dogs, rabbits, guinea pigs, ferrets, hamsters, mice, gerbils, horses, cows, goats, sheep, donkeys, pigs, and the like. In one aspect, the companion animal can be a canine. In another aspect, the companion animal can be a feline.

The term “caloric contribution ratio” refers to the ratio of macronutrients measured as percentages of caloric contribution from the respective food compositions. For example, the caloric contribution ratio of protein to fat would be measured as the caloric percentage of protein from the food composition divided by the caloric percentage of fat from the food composition.

The term “therapeutically effective amount” means an amount of a compound disclosed herein that (i) treats or prevents the particular disease, condition, or disorder, (ii) attenuates, ameliorates, or eliminates one or more symptoms of the particular disease, condition, or disorder, or (iii) prevents or delays the onset of one or more symptoms of the particular disease, condition, or disorder described herein.

The terms “treating”, “treat”, and “treatment” embrace both preventative, i.e., prophylactic, and palliative treatment.

The term “health and/or wellness of an animal” means the complete physical, mental, and social well-being of the animal, not merely the absence of disease or infirmity.

The term “in conjunction” means that the food composition, components thereof, or other compositions disclosed herein are administered to an animal (1) together in a single food composition or (2) separately at the same or different frequency using the same or different administration routes at about the same time or periodically. “Periodically” means that the food composition, components thereof, or other compositions are administered on a schedule acceptable for specific compounds or compositions. “About the same time” generally means that the food composition, components thereof, or other compositions are administered at the same time or within about 72 hours of each other.

The term “food” or “food product” or “food composition” means a product or composition that is intended for ingestion by an animal, including a human, and provides nutrition to the animal.

The term “carbohydrate” refers to carbohydrates that are digestible, e.g., sugars and starches, and does not include fiber, e.g., cellulose or fermentable fibers.

The term “crude fiber” refers to part of insoluble fiber found in the edible portion of the plant cell wall, and crude fiber is a measure of the quantity of indigestible cellulose, lignin, and other components of this type in foods.

The term “total dietary fiber” refers to the portion of plant-derived food that cannot be completely broken down by animal digestive enzymes and includes both soluble and insoluble fibers. Soluble fiber dissolves in water and is fermented in the colon by gut microbiota. Examples of soluble fibers are beta-glucans, guar gum, Psyllium, inulin, wheat dextrin, resistant starches. Insoluble fiber does not dissolve in water. Examples of insoluble fibers are cellulose and lignin.

The term “regular basis” means at least monthly administration and, in one aspect, at least weekly administration. More frequent administration or consumption, such as twice or three times weekly, can be performed in certain embodiments. In one aspect, an administration regimen can comprise at least once daily consumption.

The term “single package” means that the components of a kit are physically associated in or with one or more containers and considered a unit for manufacture, distribution, sale, or use. Containers include, but are not limited to, bags, boxes, cartons, bottles, packages such as shrink wrap packages, stapled or otherwise affixed components, or combinations thereof. A single package may be containers of the food compositions, or components thereof, physically associated such that they are considered a unit for manufacture, distribution, sale, or use.

The term “virtual package” means that the components of a kit are associated by directions on one or more physical or virtual kit components instructing the user how to obtain the other components, e.g., in a bag or other container containing one component and directions instructing the user to go to a website, contact a recorded message or a fax-back service, view a visual message, or contact a caregiver or instructor to obtain instructions on how to use the kit or safety or technical information about one or more components of a kit.

The term “about” means plus or minus 20% of a numeric value; in one aspect, plus or minus 10%; in another aspect, plus or minus 5%; and in one specific aspect, plus or minus 2%. For example, in one aspect where about is plus or minus 20% of a numeric value, the phrase “from about 10% to about 20%” could include a range from 8% to 24% or 12% to 16%, include any subranges therein.

As used herein, embodiments, aspects, and examples using “comprising” language or other open-ended language can be substituted with “consisting essentially of” and “consisting of” embodiments.

The term “complete and balanced” when referring to a food composition means a food composition that contains all known required nutrients in appropriate amounts and proportions based on recommendations of recognized authorities in the field of animal nutrition and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO). In one embodiment, “complete and balanced” can be according to the current standards published by AAFCO as of Jan. 1, 2021.

All percentages expressed herein are by weight of the composition on a dry matter basis unless specifically stated otherwise. The skilled artisan will appreciate that the term “dry matter basis” means that an ingredient's concentration or percentage in a composition is measured or determined after any free moisture in the composition has been removed.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a supplement”, “a method”, or “a food” includes a plurality of such “supplements”, “methods”, or “foods.” Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, certain compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### DETAILED DESCRIPTION

The present methods and compositions are based upon the discovery that specific food components work synergistically to provide health benefits in an animal. Specifically, the present food compositions utilize a ratio of protein to carbohydrate, omega-3 fatty acids, and isoflavones that enhances satiety, preserves lean body mass during weight loss, and provides health benefits as compared to known treatment regimens such as low caloric food compositions, dieting, or the use of costly additives or supplements. However, the use of such treatments can be used in conjunction with the methods and compositions.

In one embodiment, a pet food composition can comprise protein, fat, carbohydrates, omega-3 fatty acids, and isoflavones; wherein the protein to carbohydrate is in a ratio ranging from 3.5:1 to 2.5:1 by weight as fed.

In another embodiment, a method for providing a health benefit in an animal can comprise administering a food composition to the animal, wherein the food composition comprises protein, fat, carbohydrates, omega-3 fatty acids, and isoflavones; wherein the protein to carbohydrate is in a ratio ranging from 3.5:1 to 2.5:1 by weight as fed.

While the present diets generally have high protein and low carbohydrates, the present macronutrient profile is unique, having specific ratios and components that provide unexpected benefits. Notably, the present diets are not ketogenic diets (traditional or modified), i.e., diets that rely on high fat or diets having fat as the predominant component of the diet. Further, the present diet is set apart from general high protein diets as shown in the Examples below. Rather than relying on a single macronutrient component or ratio, the present methods and compositions rely on unique combination of macronutrient ratios and food components that were previously not understood in the art.

Generally, the present compositions comprise a protein. The protein can be crude protein material and may comprise vegetable proteins such as soybean meal, soy protein concentrate, corn gluten meal, wheat gluten, cottonseed, pea protein, canola meal, and peanut meal, or animal proteins such as casein, albumin, and meat protein. Examples of meat protein useful herein include beef, pork, lamb, equine, poultry, fish, and mixtures thereof. The compositions may also optionally comprise other materials such as dried whey and other dairy by-products. In one embodiment, the food compositions can comprise protein in amounts from about 25%, 30%, 35%, 40%, 45%, 50%, or even 55% to about 35%, 40%, 45%, 50%, 55%, or even 60% by weight, including various subranges within these amounts. In one aspect, the protein can be from about 40% to about 60% of the food composition by weight. In another aspect, the protein can be from about 45% to about 55% of the food composition by weight.

Notwithstanding the aforementioned proteins, the present compositions comprise isoflavones. In various embodiments, the isoflavones include at least one of daidzein, 6-O-malonyl daidzein, 6-O-acetyl daidzein, genistein, 6-O-malonyl genistein, 6-O-acetyl genistein, glycitein, 6-O-malonyl glycitein, 6-O-acetyl glycitein, biochanin A, or formononetin. The isoflavones or metabolites thereof can be from soybean (Glycine max) in certain embodiments. Where present, the one or more metabolites preferably include equol. In one embodiment, the food compositions can comprise isoflavones in amounts from about 300 mg, 400 mg, 500 mg, 600 mg, 700 mg, 800 mg, 900 mg, or even 1,000 mg per kg of the food composition to about 500 mg; 600 mg; 700 mg; 800 mg; 900 mg; 1,000 mg; 1,100 mg; 1,200 mg; 1,300 mg; 1,400 mg; or even 1,500 mg per kg of the food composition, including various subranges within these amounts. In one aspect, the isoflavones can present in an amount from about 100 mg to 1,500 mg per kilogram of the pet food composition. In another aspect, the isoflavones can present in an amount from about 300 mg to 1,200 mg per kilogram of the pet food composition.

Generally, any type of carbohydrate can be used in the food compositions. Examples of suitable carbohydrates include grains or cereals such as rice, corn, millet, sorghum, alfalfa, barley, soybeans, canola, oats, wheat, rye, triticale and mixtures thereof. In one embodiment, the carbohydrate comprises from about 15% to about 25% of the food composition by weight. In another embodiment, the carbohydrate comprises from about 10% to about 20% of the food compositions by weight. In other aspects, the carbohydrate can be present in amounts from about 5%, 10%, 15%, or even 20%, to about 10%, 15%, 20%, or even 25% by weight.

Generally, the protein and carbohydrates are in ratios that provide a health benefit to the animal. Typically, the ratio of protein to carbohydrate ranges from 3.5:1 to 2.5:1 by weight. In some aspects, the ratio of protein to carbohydrate can range from 3.25:1 to 2.75:1, or even from 3.15:1 to 3:1 by weight.

Generally, the food compositions include fat. Examples of suitable fats include animal fats and vegetable fats. In one aspect, the fat source can be an animal fat source such as tallow, lard, or poultry fat. Vegetable oils such as corn oil, sunflower oil, safflower oil, grape seed oil, soybean oil, olive oil, fish oil and other oils rich in monounsaturated and n-6 and n-3 polyunsaturated fatty acids, may also be used. In one embodiment, the food compositions can comprise fat in amounts from about 15%, 20%, 25%, 30%, 35%, or even 40% to about 20%, 25%, 30%, 35%, 40%, or even 45%, including various subranges within these amounts by weight. In one aspect, the fat comprises from about 20% to about 40% of the food composition by weight. In another aspect, the fat comprises from about 25% to about 35% of the food composition by weight.

Notwithstanding the aforementioned fats, the present compositions comprise omega-3 fatty acids. Non-limiting examples of suitable omega-3 fatty acids include eicosapentaenoic acid (EPA), docosahexaenoic acid (DHA), alpha-linolenic acid (ALA), stearidonic acid (SDA), eicosatrienoic acid (ETE), eicosatetraenoic acid (ETA), heneicosapentaenoic acid (HPA), docosapentaenoic acid (DPA), tetracosapentaenoic acid, tetracosahexaenoic acid (nisinic acid) and mixtures thereof. In one embodiment, the omega-3 fatty acids can range from about 0.1%, 0.2%, 0.5%, 1%, 1.5%, 2%, 2.5%, or even 3% to about 1%, 1.5%, 2%, 2.5%, 3%, 3.5%, 4%, 4.5%, or even 5% of the composition by weight. In some embodiments, the omega-3 fatty acids are present in the food composition in an amount from about 0.1% to about 5% by weight. In some embodiments, the omega-3 fatty acids are present in the food composition in an amount from about 0.5% to about 2.5% by weight.

In addition to the fats and fatty acids discussed herein, the present compositions can comprise omega-6 fatty acids. Non-limiting examples of suitable omega-6 fatty acids include linoleic acid (LA), gamma-linolenic acid (GLA), arachidonic acid (AA, ARA), eicosadienoic acid, calendic acid, dihomo-gamma-linolenic acid (DGLA), docosadienoic acid, adrenic acid, osbond acid, tetracosatetraenoic acid, tetracosapentaenoic acid, and mixtures thereof. In one embodiment, the omega-6 fatty acids can range from about 0.2%, 0.5%, 1%, 2%, or even 3% to about 1%, 2%, 3%, 4%, or even 5% of the composition by weight. In some embodiments, the omega-6 fatty acids are present in the food composition in an amount from about 1% to about 5% by weight. In some embodiments, the omega-6 fatty acids are present in the food composition in an amount from about 1% to about 2% by weight.

The administration can be performed on as-needed basis, an as-desired basis, a regular basis, or intermittent basis. In one aspect, the food composition can be administered to the animal on a regular basis. In one aspect, at least weekly administration can be performed. More frequent administration or consumption, such as twice or three times weekly, can be performed in certain embodiments. In one aspect, an administration regimen can comprise at least once daily consumption.

According to the presently described methods, administration, including administration as part of a dietary regimen, can span a period ranging from parturition through the adult life of the animal. In various embodiments, the animal can be a human or companion animal such as a dog or cat. In certain embodiments, the animal can be a young or growing animal. In other embodiments, administration can begin, for example, on a regular or extended regular basis, when the animal has reached more than about 10%, 20%, 30%, 40%, or 50% of its projected or anticipated lifespan. In some embodiments, the animal can have attained 40, 45, or 50% of its anticipated lifespan. In yet other embodiments, the animal can be older having reached 60, 66, 70, 75, or 80% of its likely lifespan. A determination of lifespan may be based on actuarial tables, calculations, estimates, or the like, and may consider past, present, and future influences or factors that are known to positively or negatively affect lifespan. Consideration of species, gender, size, genetic factors, environmental factors and stressors, present and past health status, past and present nutritional status, stressors, and the like may also influence or be taken into consideration when determining lifespan.

Such administration can be performed for a time required to accomplish one or more objectives described herein, e.g., preserving lean body mass in an animal during weight loss. Other administration amounts may be appropriate and can be determined based on the animal's initial weight as well as other variables such as species, gender, breed, age, desired health benefit, etc.

The moisture content for such food compositions varies depending on the nature of the food composition. The food compositions may be dry compositions (e.g., kibble), semi-moist compositions, wet compositions, or any mixture thereof. In one embodiment, the composition can be a pet food composition, and in one aspect, can be a complete and nutritionally balanced pet food. In this embodiment, the pet food may be a “wet food”, “dry food”, or food of “intermediate moisture” content. “Wet food” describes pet food that is typically sold in cans or foil bags and has a moisture content typically in the range of about 70% to about 90%. “Dry food” describes pet food that is of a similar composition to wet food but contains a limited moisture content typically in the range of about 5% to about 15% or 20% (typically in the form or small biscuit-like kibbles). In one embodiment, the compositions can have moisture content from about 5% to about 20%. Dry food products include a variety of foods of various moisture contents, such that they are relatively shelf-stable and resistant to microbial or fungal deterioration or contamination. Also, in one aspect, dry food compositions can be extruded food products for either humans or companion animals. In one aspect, the pet food composition can be formulated for a dog. In another aspect, the pet food composition can be formulated for a cat.

The food compositions may also comprise one or more fiber sources. Such fiber sources include fiber that is soluble, insoluble, fermentable, and nonfermentable. Such fibers can be from plant sources such as marine plants, but microbial sources of fiber may also be used. A variety of soluble or insoluble fibers may be utilized, as will be known to those of ordinary skill in the art. The fiber source can be beet pulp (from sugar beet), gum arabic, gum talha, psyllium, rice bran, corn bran, wheat bran, oat bran, carob bean gum, citrus pulp, pectin, fructooligosaccharide, short chain oligofructose, mannanoligofructose, soy fiber, arabinogalactan, galactooligosaccharide, arabinoxylan, cellulose, chicory, or mixtures thereof.

Alternatively, the fiber source can be a fermentable fiber. Fermentable fiber has previously been described to provide a benefit to the immune system of a companion animal. Fermentable fiber or other compositions known to skilled artisans that provide a prebiotic to enhance the growth of probiotics within the intestine may also be incorporated into the composition to aid in the enhancement of the benefits described herein or to the immune system of an animal.

In one embodiment, the food compositions can include a total dietary fiber from about 1% to about 15% by weight. In some aspects, the total dietary fiber can be included in an amount from about 5% to about 15% by weight, or even from about 8% to about 13% by weight. In another embodiment, the food compositions can include crude fiber from about 1% to about 10% by weight. In some aspects, the crude fiber can be included in an amount from about 3% to about 10% by weight, or even from about 3% to about 7% by weight.

In some embodiments, the ash content of the food composition ranges from less than 1% to about 15%. In one aspect, the ash content can be from about 5% to about 10%.

Generally, the food composition can be suitable for consumption by an animal, including humans and companion animals such as dogs and cats, as a meal, component of a meal, a snack, or a treat. Such compositions can include complete foods intended to supply the necessary dietary requirements for an animal. Examples of such food compositions include but are not limited to dry foods, wet foods, drinks, bars, frozen prepared foods, shelf prepared foods, and refrigerated prepared foods.

Food compositions may further comprise one or more substances such as vitamins, minerals, antioxidants, probiotics, prebiotics, salts, and functional additives such as palatants, colorants, emulsifiers, and antimicrobial or other preservatives. Minerals that may be useful in such compositions include, for example, calcium, phosphorous, potassium, sodium, iron, chloride, boron, copper, zinc, magnesium, manganese, iodine, selenium, and the like. Examples of additional vitamins useful herein include such fat-soluble vitamins as A, D, E, and K and water-soluble vitamins including B vitamins, and vitamin C. Inulin, amino acids, enzymes, coenzymes, and the like may be useful to include in various embodiments.

The present methods for increasing satiety can provide a health benefit to the animal. In one embodiment, the health benefit can include preservation of lean body mass, minimization of lean body mass during weight loss, reduced body fat, reduced weight, reduced weight gain, reduced insulin resistance, decreased risk of diabetes, decreased risk of prediabetes, lower cholesterol, lower glucose, lower triglycerides, lower insulin, improved insulin sensitivity, lower leptin, prevention of prediabetes, delaying onset of prediabetes, treatment of prediabetes, prevention of diabetes, delaying onset of diabetes, treatment of diabetes, prevention of insulin resistance, delaying onset of insulin resistance, treatment of insulin resistance, prevention of overweight or obesity, delaying onset of overweight or obesity, treatment of overweight or obesity, promoting metabolic health, promoting better blood glucose management, lowering chronic inflammation and proinflammatory cytokines, improving voluntary daytime activity, reducing restlessness at daytime and nighttime, increasing satiety, and combinations thereof.

In various embodiments, the food compositions contain at least one of (1) one or more probiotics; (2) one or more inactivated probiotics; (3) one or more components of inactivated probiotics that promote health benefits similar to or the same as the probiotics, e.g., proteins, lipids, glycoproteins, and the like; (4) one or more prebiotics; and (5) combinations thereof. The probiotics or their components can be integrated into the food compositions (e.g., uniformly or non-uniformly distributed in the compositions) or applied to the food compositions (e.g., topically applied with or without a carrier). Such methods are known to skilled artisans, e.g., U.S. Pat. No. 5,968,569 and related patents.

Typical probiotics include, but are not limited to, probiotic strains selected from Lactobacilli, Bifidobacteria, or Enterococci, e.g., Lactobacillus reuteii, Lactobacillus acidophilus, Lactobacillus animalis, Lactobacillus ruminis, Lactobacillus johnsonii, Lactobacillus casei, Lactobacillus paracasei, Lactobacillus rhamnosus, Lactobacillus fermentum, and Bifidobacterium sp., Enterococcus faecium and Enterococcus sp. In some embodiments, the probiotic strain can be selected from the group consisting of Lactobacillus reuteri (NCC2581; CNCM I-2448), Lactobacillus reuteri (NCC2592; CNCM I-2450), Lactobacillus rhamnosus (NCC2583; CNCM I-2449), Lactobacillus reuteri (NCC2603; CNCM I-2451), Lactobacillus reuteri (NCC2613; CNCM I-2452), Lactobacillus acidophilus (NCC2628; CNCM I-2453), Bifidobacterium adolescentis (e.g., NCC2627), Bifidobacterium sp. NCC2657 or Enterococcus faecium SF68 (NCIMB 10415). Generally, the food compositions can contain probiotics in amounts sufficient to supply from about 10⁴ to about 10¹² cfu/animal/day, in one aspect, from 10⁵ to about 10¹¹ cfu/animal/day, and in one specific aspect, from 10′ to 10¹⁰ cfu/animal/day. When the probiotics are killed or inactivated, the amount of killed or inactivated probiotics or their components should produce a similar beneficial effect as the live microorganisms. Many such probiotics and their benefits are known to skilled artisans, e.g., EP1213970B1, EP1143806B1, U.S. Pat. No. 7,189,390, EP1482811B1, EP1296565B1, and U.S. Pat. No. 6,929,793. In one embodiment, the probiotic can be Enterococcus faecium SF68 (NCIMB 10415). In another embodiment, the probiotics can be encapsulated in a carrier using methods and materials known to skilled artisans.

As stated, the food compositions may contain one or more prebiotics, e.g., fructo-oligosaccharides, gluco-oligosaccharides, galacto-oligosaccharides, isomalto-oligosaccharides, xylo-oligosaccharides, soybean oligosaccharides, lactosucrose, lactulose, and isomaltulose. In one embodiment, the prebiotic can be chicory root, chicory root extract, inulin, or combinations thereof. Generally, prebiotics can be administered in amounts sufficient to positively stimulate the healthy microflora in the gut and cause these “good” bacteria to reproduce. Typical amounts range from about one to about 10 grams per serving or from about 5% to about 40% of the recommended daily dietary fiber for an animal. The probiotics and prebiotics can be made part of the composition by any suitable means. Generally, the agents can be mixed with the composition or applied to the surface of the composition, e.g., by sprinkling or spraying. When the agents are part of a kit, the agents can be admixed with other materials or in their own package. Typically, the food composition contains from about 0.1 to about 10% prebiotic, in one aspect, from about 0.3 to about 7%, and in one specific aspect, from about 0.5 to 5%, on a dry matter basis. The prebiotics can be integrated into the compositions using methods known to skilled artisans, e.g., U.S. Pat. No. 5,952,033.

A skilled artisan can determine the appropriate amount of food ingredients, vitamins, minerals, probiotics, prebiotics, antioxidants, or other ingredients to be used to make a particular composition to be administered to a particular animal. Such artisan can consider the animal's species, age, size, weight, health, and the like in determining how best to formulate a particular composition comprising such ingredients. Other factors that may be considered include the desired dosage of each component, the average consumption of specific types of compositions by different animals (e.g., based on species, body weight, activity/energy demands, and the like), and the manufacturing requirements for the composition.

In a further aspect, the present disclosure provides kits suitable for administering food compositions to animals. The kits comprise in separate containers in a single package or in separate containers in a virtual package, as appropriate for the kit component, one or more of (1) one or more ingredients suitable for consumption by an animal; (2) instructions for how to combine the ingredients and other kit components to produce a composition useful for providing a health benefit as described herein; (3) instructions for how to use the food composition to obtain such benefits; (4) one or more probiotics; (5) one or more inactivated probiotics; (6) one or more components of inactivated probiotics that promote health benefits similar to or the same as the probiotics, e.g., proteins, lipids, glycoproteins, and the like; (7) one or more prebiotics; (8) a device for preparing or combining the kit components to produce a composition suitable for administration to an animal; and (9) a device for administering the combined or prepared kit components to an animal. In one embodiment, the kit comprises one or more ingredients suitable for consumption by an animal. In another embodiment, the kit comprises instructions for how to combine the ingredients to produce a composition useful for obtaining a health benefit as described herein.

When the kit comprises a virtual package, the kit is limited to instructions in a virtual environment in combination with one or more physical kit components. The kit contains components in amounts sufficient for to obtain a health benefit as described herein. Typically, the kit components can be admixed just prior to consumption by an animal. The kits may contain the kit components in any of various combinations and/or mixtures. In one embodiment, the kit contains a container of food for consumption by an animal. The kit may contain additional items such as a device for mixing ingredients or a device for containing the admixture, e.g., a food bowl. In another embodiment, the food compositions can be mixed with additional nutritional supplements such as vitamins and minerals that promote good health in an animal. The components can be each provided in separate containers in a single package or in mixtures of various components in different packages. In some embodiments, the kits comprise one or more other ingredients suitable for consumption by an animal. In one aspect, such kits can comprise instructions describing how to combine the ingredients to form a food composition for consumption by the animal, generally by mixing the ingredients or by applying optional additives to the other ingredients, e.g., by sprinkling nutritional supplements on a food composition.

In a further aspect, a means for communicating information about or instructions for one or more of (1) using a food composition for obtaining one of the health benefits described herein; (2) contact information for consumers to use if they have a question regarding the methods and compositions described herein; and (3) nutritional information about the food composition can be provided. The communication means can be useful for instructing on the benefits of using the present methods or compositions and communicating the approved methods for administering food compositions to an animal. The means comprises one or more of a physical or electronic document, digital storage media, optical storage media, audio presentation, audiovisual display, or visual display containing the information or instructions. In one aspect, the means can be selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

In another aspect, methods for manufacturing a food composition comprising one or more other ingredients suitable for consumption by an animal, e.g., one or more of protein, fat, carbohydrate, fiber, vitamins, minerals, probiotics, prebiotics, and the like, can comprise admixing one or more of the ingredients suitable for consumption by an animal. The composition can be made according to any method suitable in the art.

In another aspect, a package useful for containing compositions described herein can comprise at least one material suitable for containing the food composition and a label affixed to the package containing a word or words, picture, design, acronym, slogan, phrase, or other device, or combination thereof that indicates that the contents of the package contains the food composition. In some embodiments, the label affixed to the package contains a word or words, picture, design, acronym, slogan, phrase, or other device, or combination thereof that indicates that the contents of the package contains the food composition with beneficial properties relating to a health benefit described herein. In one aspect, such device can comprise the words “enhances satiety,” or an equivalent or similar expression printed on the package. Any package configuration and packaging material suitable for containing the composition can be used herein, e.g., bag, box, bottle, can, pouch, and the like manufactured from paper, plastic, foil, metal, and the like. In one embodiment, the package contains a food composition adapted for a particular animal such as a human, canine, or feline, as appropriate for the label, in one aspect, a companion animal food composition for dogs or cats. In one embodiment, the package can be a can or pouch comprising a food composition described herein. In various embodiments, the package further comprises at least one window that permit the package contents to be viewed without opening the package. In some embodiments, the window can be a transparent portion of the packaging material. In others, the window can be a missing portion of the packaging material.

### EXAMPLES

The invention can be further illustrated by the following example, although it will be understood that this example is included merely for purposes of illustration and is not intended to limit the scope of the invention unless otherwise specifically indicated.

### Example 1—Cat Study I

Two panel of cats, with 20 cats per panel, were studied to determine the effects of diets on satiety and voluntary food intake in cats. The cats had free access to either control or test diet for two days, and after 2-5 days of break, the cats were switched to the opposite diets for two more days with free access to the corresponding diets. The number of meals, time between meals, time spent on each mean and total caloric intake were recorded. The macronutrient breakdown of the diets used are found in Table 1.

TABLE 1

| Test Diet | | | Control diet | | |
|---|---|---|---|---|---|
| | Caloric | | | Caloric | |
| Macro | contri- | | Macro | contri- | |
| Nutrients | bution % | Ratio | Nutrients | bution % | Ratio |
| Protein | 52 | 3.1 | Protein | 38 | 1.2 |
| Fat | 31 | 1.8 | Fat | 31 | 1 |
| Carbohydrate | 17 | 1 | Carbohydrate | 31 | 1 |

As shown in Tables 2-5, when the cats were fed the test diet, the cats ate bigger test meals and increased eating rate (g food/min), but they increased the time between meals and ate few meals per day, which led to significant reduction of voluntary daily caloric intake. These data confirm that the test diet significantly enhanced satiety and reduced voluntary food intake. Further, the increased rate of consumption of the test diet proves that the overall difference in consumption (and the presently claimed benefits) was not due to the test diet having poor palatability.

TABLE 2

| | | |
|---|---|---|
| Total Consumption (g) | Control diet | 54.1791 |
| Total Consumption (g) | Test diet | 47.2930 |

TABLE 3

| | | |
|---|---|---|
| Avg. Eating Rate (g/min.) | Control diet | 2.5982 |
| Avg. Eating Rate (g/min.) | Test diet | 2.7776 |

TABLE 4

| | | |
|---|---|---|
| Avg. Cons. per Meal (g) | Control diet | 6.0349 |
| Avg. Cons. per Meal (g) | Test diet | 6.5955 |

TABLE 5

| | | |
|---|---|---|
| Total Number of Meals | Control diet | 9.4186 |
| Total Number of Meals | Test diet | 7.4535 |

As can be seen in Table 5, the test diet significantly reduced the number of the meals per day, which is responsible for the reduction of voluntary food intake in the cats. Further as can be seen in Table 6, below, the test diet results in increased times between meals thereby substantiating that the cats fed the test diets had higher levels of satiety.

TABLE 6

| | | |
|---|---|---|
| Avg. Time between Meals (minutes) | Control diet | 94 |
| Avg. Time between Meals (minutes) | Test diet | 138 |

These data confirm that the test diet significantly enhanced satiety, which resulted in the reduction of voluntary food intake in the cats. Reduced voluntary food intake in cats will significantly reduce weight gain, and help cats maintain healthy weight and metabolic health.

### Example 2—Cat Study II

Forty-five adult cats were randomized into three groups with 15 cats per group based on their baseline maintenance energy requirement (MER), percentage of body, BCS, and body weight. The groups were fed three different diets with varying ratios for protein to fat to carbohydrates (CHO) as found in Table 7.

TABLE 7

| | | | Group 2: | | Group 3: | |
|---|---|---|---|---|---|---|
| | Group 1: | | High Protein, | | High Protein, | |
| Macro | Control diet | | Moderate CHO | | Low CHO | |
| Nutrients | %* | Ratio | %* | Ratio | %* | Ratio |
| Protein | 30.95 | 1 | 47.49 | 2.4 | 54.23 | 4.7 |
| Fat | 33.91 | 1.1 | 32.66 | 1.6 | 34.22 | 3.0 |
| Carbohydrate | 35.14 | 1.1 | 19.85 | 1 | 11.55 | 1 |

*Percent of total dietary calories as fed

The cats were fed 25% more than their baseline MERs for a period of 12 months. As shown in Table 8, the average food intake was not significantly different between groups, and in fact, the diet with the highest protein (Group 3) had the highest consumption.

TABLE 8

| Group | Total Consumption (g) | Standard Error |
|---|---|---|
| Group 1 | 60.2714 | 1.9 |
| Group 2 | 58.5514 | 2.2 |
| Group 3 | 61.2767 | 2.2 |

As shown above, the diets of Table 7 provided no satiety benefit. Even high protein diets did not provide a satiety benefit further showing that the satiety benefit of the test diet of Example 1 was wholly unexpected.

### Example 3—Cat Study III

In the cat study, thirty overweight cats were randomized into two groups based on their baseline maintenance energy requirement (MER), body weight, body fat, age, and gender. During the study, all cats were fed 25% less than their baseline MERs. The administered diets are listed in Table 9. The cats were administered each diet for 6 months. Body weight was recorded weekly, and body composition was measured monthly by quantitative magnetic resonance (QMR) technology.

TABLE 9

| Ingredients | Diet I (%) | Diet II (%) |
|---|---|---|
| Protein | 53.7 | 34.6 |
| Carbohydrate (CHO) | 12.1 | 33.5 |
| Fat | 15.4 | 13.6 |
| Fiber | 4.26 | 3.74 |
| Protein:CHO | 4.44:1 | 1:1 |

At the end of the 6-month study, cats fed Diet I lost more body weight than the cats fed Diet II (645.54 g vs 513.50 g); however, both sets of cats lost lean body mass as shown in Table 10.

TABLE 10

| | Average Lean Loss | Average Fat Loss |
|---|---|---|
| | (grams) | (% change from baseline) |
| Cats Fed Diet II | 151 g | 3.58% |
| Cats Fed Diet I | 105.9 g | 7.60% |

### Example 4—Dog Study I

In this study, 30 overweight dogs were randomized into two groups with 15 dogs per group based on their baseline maintenance energy requirement (MER), body weight, % body fat, and genders. The dogs in both the control and test groups were fed 75% if their baseline MERs during the first 4 months of the weight loss study and then 60% of their baseline MERs during the last 2 months of the weight loss study. The body composition was determined with a DEXA machine. The diets are shown in Table 11.

TABLE 11

| Components | Test diet (wt %) | Control diet (wt %) |
|---|---|---|
| Moisture | 8.07 | 8.09 |
| Protein | 48.70 | 26.47 |
| Starch | 15.65 | 31.60 |
| Fat | 10.1 | 14.73 |
| Crude fiber | 5.00 | 11.40 |
| Total dietary fiber | 12.93 | 19.70 |
| Ash | 5.94 | 5.19 |
| n-3 PUFAs* | 1.2166 | 0.08902 |
| n-6 PUFAs** | 1.53587 | 1.62164 |
| Total Isoflavones (mg/kg) | 965.33 | 138.67 |

*Omega-3 Polyunsaturated fatty acids
**Omega-6 Polyunsaturated fatty acids

There was no significant difference in lean body mass between baseline and any of the three time points (2 months, 4 months, and 6 months) in dogs fed the test diet. On the contrary, dogs fed the control diet lost significant amount of lean body mass at all three time points compared with baseline as shown in Table 12.

TABLE 12

| | Lean Body Mass - | | | Lean Body Mass - | | |
|---|---|---|---|---|---|---|
| | Control diet | | | Test diet | | |
| Time | Initial | Final | Difference | Initial | Final | Difference |
| Period | (kg) | (kg) | (kg) | (kg) | (kg) | (kg) |
| 2 months | 20.29 | 19.60 | −0.69 | 20.09 | 20.32 | 0.24 |
| 4 months | 20.29 | 19.75 | −0.54 | 20.09 | 20.08 | 0.05 |
| 6 months | 20.29 | 19.54 | −0.75 | 20.09 | 19.88 | −0.15 |

Dogs in both groups lost significant amount of body fat compared with baseline. However, dogs fed the test diet lost more body fat than the control dogs (5.93 kg vs 4.98 kg) at the end of the 6-month weight loss study as shown in Table 13.

TABLE 13

| | Body Fat - | | | Body Fat - | | |
|---|---|---|---|---|---|---|
| | Control diet | | | Test diet | | |
| Time | Initial | Final | Difference | Initial | Final | Difference |
| Period | (kg) | (kg) | (kg) | (kg) | (kg) | (kg) |
| 2 months | 13.35 | 12.00 | −1.35 | 13.38 | 11.31 | −2.07 |
| 4 months | 13.35 | 10.47 | −2.88 | 13.38 | 9.60 | −3.68 |
| 6 months | 13.35 | 8.37 | −4.98 | 13.38 | 7.35 | −5.93 |

Dogs fed the control diet increased their daytime spontaneous activity more than the dogs fed the test diet compared with their baseline spontaneous daytime activity even dogs in both groups were fed 25% less than their baseline maintenance energy requirement (MERs). More strikingly, dogs fed the control diet increased their nighttime spontaneous activity compared with their baseline spontaneous nighttime activity, indicating that the control dogs were more restless at nighttime. On the contrary, dogs fed the test diet lowered their spontaneous nighttime activity compared with their baseline spontaneous nighttime activity, indicating that the dogs on the test diet were even less restless during weight loss than at baseline when they were fed 100% of their MERs without any caloric deficiency. These data as shown in Table 14 indicate that the test diet reduces restlessness in dogs compared with the control diet during weight loss.

TABLE 14

| | % change over | % change over |
|---|---|---|
| | baseline in daytime | baseline in nighttime |
| Diet Groups | activity | activity |
| Control | 54.94 | 9% |
| Test | 32.73 | −11.61 |

### Example 5—Dog Study II

The objective of the study was to investigate whether soy isoflavone alone or a combination of soy isoflavones, conjugated linoleic acid (CLA), and carnitine can promote fat loss, and preserve lean body mass in overweight dogs.

The control diet was formulated based on a low-calorie weight loss formula. The isoflavone diet was the control diet supplemented with 10% soy germ meal. The cocktail diet was the control diet supplemented with 10% soy germ meal, 1.5% conjugated linoleic acid (CLA), and 100 ppm L-carnitine. All three diets had comparable levels of protein, fat, fiber, and carbohydrate.

The diets are shown in Table 15 as follows: Ration 1: a traditional weight loss control diet (metabolizable energy=1338.8 kcal/lb). Ration 2: Isoflavone diet (metabolizable energy=1346.3 kcal/lb): the control diet containing 10% soy germ meal (SGM containing 6500 to 8400 mg/kg isoflavones). Ration 3: Cocktail diet (metabolizable energy=1309.8 kcal/lb): the control diet containing 10% SGM, CLA (1.5%), and L-carnitine (100 ppm).

TABLE 15

| | | | | | | Total |
|---|---|---|---|---|---|---|
| | | | | | | isoflavone |
| | | | | Carbo- | Crude | (Aglycone |
| | ME* | Protein | Fat | hydrate | Fiber | units) |
| Ration | (kcal/lb) | (wt %) | (wt %) | (wt %) | (wt %) | (mg/kg) |
| 1 | 1338.8 | 26.3 | 6.78 | 44.9 | 6.69 | 30-80 |
| 2 | 1346.3 | 26.8 | 6.13 | 44.4 | 7.26 | 680-950 |
| 3 | 1309.8 | 27.0 | 7.57 | 42.2 | 6.75 | 660-930 |

*ME = metabolizable energy

Over-weight dogs with more than 22% body fat (male dogs) and 26% body fat (female dogs) were randomized into three groups and fed 70% of their MER during the first 3-month of weight loss. Dexa scan was performed on each dogs three months and six months after the initiation of the study. Dogs that failed to reach their ideal body fat levels after the first 3 months of weight loss were fed 55% of their MER during the second 3-month of weight loss.

Changes in body fat and lean body mass after 3 and 6 months of weight loss are summarized in Table 16 (mean). After both the 3-month mark and the 6-month mark, the isoflavone diet did not prevent the loss of lean body mass. Even when supplemented with other actives, the cocktail diet did not preserve lean body mass at the end of the trial (6-month mark).

TABLE 16

| | Test diets | 3-month | 6-month |
|---|---|---|---|
| Change in Lean Tissue | Control | −399.5 | −578.3 |
| (g) from baseline | Isoflavones | −173 | −159.8 |
| | Cocktail | +267 | −283 |
| Change in body fat | Control | −4385.9 | −7722.6 |
| (g) From baseline | Isoflavones | −3889.3 | −7097.1 |
| | Cocktail | −5158.2 | −9198.3 |

### Other Studies

In addition to the above, other published works have demonstrated that omega-3 fatty acids alone do not preserve lean body mass and protein to carb ratios alone do not preserve lean body mass.

Diez et al. (Diez, M., Nguyen, P., Jeusette, I., Devois, C., Istasse, L. & Biourge, V., “Weight loss in obese dogs: evaluation of a high-protein, low-carbohydrate diet” J. Nutr. 132: 1685S-1687S (2002)) reported obese dogs fed a high protein (47.5%), low starch (5.3%) diet with a protein to starch ratio of 9:1 had 20% of weight loss came from lean body mass. In addition, dogs fed a diet with 2.4 to 1 protein to carbohydrate ratio lost significant amount of lean body mass after 16 weeks of weight loss (A. Andre, I. Leriche, G. Chaix, C. Thorin, M. Burger, P. Nguyen, “Recovery of Insulin and optimal body composition after rapid weight loss in obese dogs fed a high-protein medium-carbohydrate diet”, J. of Animal Physiology and Animal Nutrition 2017, 101:21-30). Bender et al. (N Bender, M. Portmann, Z. Heg, K. Hofmann, M. Zwahlen, M. Egger, “Fish or n3-PUFA intake and body composition: a systematic review and meta-analysis” Obesity Reviews 2014, 15: 657-665) reported that including fish or fish oil in weight loss diets didn't result in significant difference in either fat mass or lean body mass after weight loss in people, compared with control diets.

The protein level of the present test diet (48.7%) was similar to that of the Diez's test diet, but the test diet contained more starch (14.2%) as well as isoflavones and omega-3 fatty acids. To the inventor's surprise, those nutrients unexpectedly worked synergistically to promote fat mobilization and preserve lean body mass during the weight loss study in dogs, leading to the unexpected total prevention of the loss in lean body mass even after 40% reduction in caloric intake during the 6-month weight loss.

In the specification, there have been disclosed certain embodiments of the invention. Although specific terms are employed, they are used in a generic and descriptive sense only and not for purposes of limitation. The scope of the invention is set forth in the claims. Obviously, many modifications and variations of the invention are possible in light of the above teachings. It is therefore to be understood that within the scope of the appended claims, the invention may be practiced otherwise than as specifically described.

What is claimed is:

1. A pet food composition, comprising protein, fat, carbohydrates, omega-3 fatty acids, and isoflavones; wherein the protein to carbohydrate is in a ratio ranging from 3.5:1 to 2.5:1 by weight as fed.

2. The composition of claim 1, wherein the omega-3 fatty acids are selected from the group consisting of eicosapentaenoic acid (EPA), docosahexaenoic acid (DHA), alpha-linolenic acid (ALA) and mixtures thereof.

3. The composition of claim 1, wherein the omega-3 fatty acids are present in an amount from about 0.1% to about 5% by weight of the pet food composition.

4. The composition of claim 1, wherein the omega-3 fatty acids are present in an amount from about 0.5% to about 2.5% by weight of the pet food composition.

5. The composition of claim 1, wherein the isoflavones are selected from the group consisting of daidzein, 6-O-malonyl daidzein, 6-O-acetyl daidzein, genistein, 6-O-malonyl genistein, 6-O-acetyl genistein, glycitein, 6-O-malonyl glycitein, 6-O-acetyl glycitein, biochanin A, formononetin, or mixtures thereof.

6. The composition of claim 1, wherein the isoflavones are present in an amount from about 100 mg to 1,500 mg per kilogram of the pet food composition.

7. The composition of claim 1, wherein the isoflavones are present in an amount from about 300 mg to 1,200 mg per kilogram of the pet food composition.

8. The composition of claim 1, wherein the protein is present in an amount from about 25% to about 60% by weight of the pet food composition and the carbohydrates are present in an amount from about 5% to about 25% by weight of the pet food composition.

9. The composition of claim 1, wherein the protein is present in an amount from about 40% to about 60% by weight of the pet food composition and the carbohydrates are present in an amount from about 10% to about 20% by weight of the pet food composition.

10. The composition of claim 1, wherein the protein to carbohydrate is in a ratio ranging from 3.25:1 to 2.75:1.

11. The composition of claim 1, wherein the pet food composition is formulated for a canine.

12. A method for providing a health benefit in an animal comprising administering a food composition to the animal, wherein the food composition comprises protein, fat, carbohydrates, omega-3 fatty acids, and isoflavones; wherein the protein to carbohydrate is in a ratio ranging from 3.5:1 to 2.5:1 by weight as fed.

13. The method of claim 12, wherein the animal is a companion animal, and the food composition is administered to the companion animal on a regular basis.

14. The method of claim 12, wherein the omega-3 fatty acids are present in the food composition in an amount from about 0.1% to about 5% by weight, wherein the isoflavones are present in the food composition in an amount from about 100 mg to 1,500 mg per kilogram of the food composition, wherein the protein is present in the food composition in an amount from about 25% to about 60% by weight, and the carbohydrates are present in the food composition in an amount from about 5% to about 25% by weight.

15. The method of claim 12, wherein the health benefit is selected from the group consisting of: preservation of lean body mass, minimization of lean body mass during weight loss, reduced body fat, reduced weight, reduced weight gain, reduced insulin resistance, decreased risk of diabetes, decreased risk of prediabetes, lower cholesterol, lower glucose, lower triglycerides, lower insulin, lower leptin, improved insulin sensitivity, prevention of prediabetes, delaying onset of prediabetes, treatment of prediabetes, prevention of diabetes, delaying onset of diabetes, treatment of diabetes, prevention of insulin resistance, delaying onset of insulin resistance, treatment of insulin resistance, prevention of overweight or obesity, delaying onset of overweight or obesity, treatment of overweight or obesity, promoting metabolic health, promoting better blood glucose management, lowering chronic inflammation and proinflammatory cytokines, improving voluntary daytime activity, reducing restlessness at daytime and nighttime, increasing satiety, and combinations thereof.
